(19) United States
(12) Patent Application Publication
(10) Pub. No.: US 2026/0188322 A1
(43) Pub. Date: Jul. 2, 2026

(54) EXTERNAL ELECTRONIC DEVICE

(71) Applicant: ASUSTEK COMPUTER INC., TAIPEI (TW)

(72) Inventors: Ting-Yu CHEN, TAIPEI (TW); Wei-Hua HUANG, TAIPEI (TW)

(21) Appl. No.: 19/187,072

(22) Filed: Apr. 23, 2025

(30) Foreign Application Priority Data
Jan. 2, 2025 (TW) 114100149

(51) Int. Cl. G10L 15/26; G06F 16/34; G10L 13/08; G10L 15/22

(52) U.S. Cl. CPC G10L 15/26; G06F 16/345; G10L 13/08; G10L 15/22; G10L 2015/223

(57) ABSTRACT

The disclosure provides a voice communication system, including a caller voice receiving unit, a voiceprint recognition unit, a voiceprint training unit, a text input unit, a language translation model, a voice generation unit, a receiver voice receiving unit, a voice recognition unit, and a text recording unit. The caller voice receiving unit, the voiceprint recognition unit, and the voiceprint training unit are configured to train a voice synthesis model by using a voice sample of a caller. The text input unit, the language translation model, and the voice generation unit are configured to generate a synthesized voice by using caller text and the voice synthesis model. The receiver voice receiving unit and the voice recognition unit are configured to convert a reply voice into reply text. The text recording unit is configured to record the caller text and the reply text. The disclosure also provides a voice communication method.

### CROSS-REFERENCE TO RELATED APPLICATION

This application claims the priority benefit of Taiwan Application Serial No. 114100149, filed on Jan. 2, 2025. The entirety of the above-mentioned patent application is hereby incorporated by reference herein and made a part of specification.

### BACKGROUND OF THE INVENTION

### Field of the Invention

The disclosure relates to the field of voice communication technologies, and in particular, to a voice communication system that generates a synthesized voice by using a voice synthesis model, and a voice communication method.

### Description of the Related Art

Conventionally, during voice communication, there are many problems such as difficult trans-language voice communication and inconvenient recording during the voice communication. When a translator or translation software translates conversation content in real time, although both parties understand the conversation content, a meeting needs to be frequently interrupted. This affects the process of the meeting, and also makes real-time recording of the conversation content difficult.

### BRIEF SUMMARY OF THE INVENTION

The disclosure provides a voice communication system, suitable for a caller. The caller is used for voice communicating with a receiver. The voice communication system includes a caller voice receiving unit, a voiceprint recognition unit, a voiceprint training unit, a text input unit, a language translation model, a voice generation unit, a receiver voice receiving unit, a voice recognition unit, and a text recording unit.

The caller voice receiving unit is configured to obtain a voice sample of the caller. The voiceprint recognition unit is electrically connected to the caller voice receiving unit, and is configured to capture and analyze a voiceprint of the voice sample to generate voiceprint data. The voiceprint training unit is electrically connected to the voiceprint recognition unit, and is configured to train a voice synthesis model by using the voiceprint data.

The text input unit is configured to obtain caller text. The language translation model is electrically connected to the text input unit, and is configured to convert the caller text into translated text. The voice generation unit is electrically connected to the voiceprint training unit and the language translation model, and is configured to generate a synthesized voice by using the voice synthesis model and the translated text.

The receiver voice receiving unit is configured to obtain a reply voice of the receiver. The voice recognition unit is electrically connected to the receiver voice receiving unit, and is configured to convert the reply voice into reply text. The text recording unit is electrically connected to the text input unit and the voice recognition unit, and is configured to record the caller text and the reply text to generate a conversation record.

The disclosure also provides a voice communication method, suitable for a caller. The caller is used for voice communicating with a receiver. The voice communication method includes a model generation stage, a communication stage, and a post-communication stage.

The model generation stage includes the following steps: first, obtaining a voice sample of the caller; subsequently, capturing and analyzing a voiceprint of the voice sample to generate voiceprint data; and then, training a voice synthesis model by using the voiceprint data.

The communication stage includes the following steps: first, obtaining caller text; subsequently, converting the caller text into translated text by using a language translation model; and then, generating a synthesized voice by using the voice synthesis model and the translated text. The post-communication stage includes: recording the caller text to generate a conversation record.

The disclosure also provides another voice communication method, suitable for a caller. The caller is used for voice communicating with a receiver. The voice communication method includes a model generation stage, a communication stage, and a post-communication stage.

The model generation stage includes the following steps: first, obtaining a voice sample of the caller; subsequently, capturing and analyzing a voiceprint of the voice sample to generate voiceprint data; and then, training a voice synthesis model by using the voiceprint data.

The communication stage includes the following steps: first, obtaining caller text through the caller; subsequently, converting the caller text into translated text by using a language translation model; then, generating a synthesized voice by using the voice synthesis model and the translated text; next, obtaining a reply voice through the receiver; and then, converting the reply voice into reply text.

The post-communication stage includes: recording the caller text and the reply text to generate a conversation record.

According to the voice communication system and the voice communication method provided in the disclosure, caller text is converted into translated text in real time by using a language translation model, and a synthesized voice is also generated in real time based on the translated text by using a language synthesis model and transmitted to a receiver. This helps to resolve the problem of difficult trans-language voice communication during conventional voice communication. In addition, according to the voice communication system and the voice communication method provided in the disclosure, during communication, the caller text and reply text of the receiver are also recorded to generate a conversation record. This helps to resolve the problem of inconvenient recording during the conventional voice communication.

### BRIEF DESCRIPTION OF THE DRAWINGS

FIG. 1 is a schematic diagram of a voice communication system according to an embodiment of the disclosure;

FIG. 2 is a schematic diagram of a voice communication system according to another embodiment of the disclosure;

FIG. 3 is a flowchart of a voice communication method according to an embodiment of the disclosure;

FIG. 4 is a flowchart of a voice communication method according to another embodiment of the disclosure; and

FIG. 5 shows an embodiment of step S460 in FIG. 4.

### DETAILED DESCRIPTION OF THE EMBODIMENTS

Embodiments of the disclosure will be described in detail with reference of schematic diagrams. The advantages and features of the disclosure will be better understand according to the following description and appended claims. It needs to be noted that accompanying drawings are all in a simplified form and in an inaccurate scale. They are only used for assisting in describing the propose of the embodiments of the disclosure in a convenient and clear way.

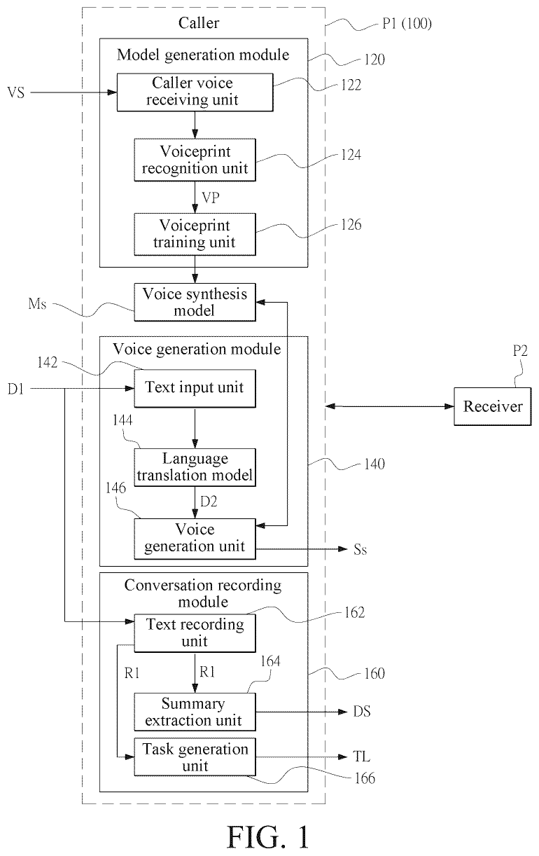

FIG. 1 is a schematic diagram of a voice communication system 100 according to an embodiment of the disclosure.

The voice communication system 100 is suitable for being installed on a caller P1. The caller P1 is used for voice communicating with a receiver P2. In an embodiment, the caller P1 has a terminal device (not shown). The terminal device is a desktop computer, a laptop computer, a tablet computer, a smartphone, or the like. The voice communication system 100 provided in this embodiment is suitable for being installed on the terminal device for operation. However, the disclosure is not limited thereto.

As shown in the figure, the voice communication system 100 includes a model generation module 120, a voice generation module 140, and a conversation recording module 160, which are separately configured to generate a voice synthesis model Ms, generate a synthesized voice Ss in real time, and generate a conversation record R1.

The model generation module 120 includes a caller voice receiving unit 122, a voiceprint recognition unit 124, and a voiceprint training unit 126.

The caller voice receiving unit 122 is configured to obtain a voice sample VS of the caller P1.

The voiceprint recognition unit 124 is electrically connected to the caller voice receiving unit 122, and is configured to capture and analyze sound features (such as a pitch, a tonality, and timbre) of the voice sample VS to generate voiceprint data VP, and build a voiceprint database corresponding to a user of the caller P1. The voiceprint data VP is stored in a memory of a terminal device (not shown) of the caller P1, to avoid privacy issues arising from uploading data to the Internet. Subsequently, after the voice communication is restarted, when it is detected that the voiceprint data VP corresponding to the user is stored in the memory, the model generation step is skipped to directly perform communication.

The voiceprint training unit 126 is electrically connected to the voiceprint recognition unit 124, and is configured to train the voice synthesis model Ms by using the voiceprint data VP. The trained voice synthesis model Ms is configured to generate the synthesized voice Ss.

In an embodiment, the voice synthesis model Ms is a deep learning model configured to simulate the features (such as the pitch, the tonality, and the timbre) of the voice sample VS, to generate a natural and real voice.

The voice generation module 140 includes a text input unit 142, a language translation model 144, and a voice generation unit 146.

The text input unit 142 is configured to obtain caller text D1. The caller text D1 is inputted by the user to the terminal device of the caller P1 through a human-machine interface such as a keyboard, or a called voice of the user of the caller P1 is converted into the caller text D1 through voice recognition.

The language translation model 144 is electrically connected to the text input unit 142, and is configured to convert the caller text D1 of an original language into translated text D2 of a target language, which relates to application of a natural language processing (NLP) technology and a machine translation (MT) technology. The natural language processing technology analyzes and understands content of the caller text D1, and recognizes syntactic structures and meanings thereof. The machine translation technology relates to conversion of corresponding words and syntactic structures between languages, and converts the caller text D1 into the translated text D2.

In an embodiment, the user of the caller P1 presets a target language of the language translation model 144 to simplify the language translation model 144. In another embodiment, the voice communication system 100 also determines a target language in real time after obtaining spoken content of a user of the receiver P2, and automatically sets the target language of the language translation model 144.

The voice generation unit 146 is electrically connected to the voiceprint training unit 126 and the language translation model 144, and is configured to generate the synthesized voice Ss by using the voice synthesis model Ms generated through training of the model generation module 120 and the translated text D2 generated through conversion of the language translation model 144. In an embodiment, to make the synthesized voice Ss more natural and real, multiple trans-language voice optimization models are trained previously. The trans-language voice optimization model is generated with phonating features and tone features of the target language as training data.

When the voice generation module 140 selects a language of the translated text D2 to be generated by the language translation model 144, the voice generation module 140 also selects a corresponding trans-language voice optimization model. The synthesized voice Ss to be generated based on the voice synthesis model Ms is provided to the receiver P2 after being optimized by the trans-language voice optimization model.

The conversation recording module 160 includes a text recording unit 162. The text recording unit 162 is electrically connected to the text input unit 142, and is configured to record all caller text D1 generated during communication in chronological order, to generate the conversation record R1. In an embodiment, the conversation recording module 160 further includes a summary extraction unit 164. The summary extraction unit 164 is electrically connected to the text recording unit 162, and is configured to generate summary text DS according to the conversation record R1.

The summary extraction unit 164 analyzes the conversation record R1 by using an extractive summarization or abstractive summarization generation method, to generate the summary text DS. In an embodiment, the summary extraction unit 164 determines an abstract subject of the conversation record R1 by using a topic model method, to generate the summary text DS.

In an embodiment, the conversation recording module 160 further includes a task generation unit 166. The task generation unit 166 is electrically connected to the text recording unit 162, and is configured to analyze the conversation record R1 to generate at least one to-be-performed task TL.

The task generation unit 166 relates to natural language understanding (NLU) and dialog management (DM) technologies. The task generation unit 166 performs intent recognition for the conversation record R1, to determine major intent and a to-be-performed task in a dialog. The task generation unit 166 performs entity recognition for the conversation record R1, to extract key information in sentences of the dialog, including time, a site, a name, and the like in the dialog. The task generation unit 166 also tracks a dialog state of each dialog in the conversation record R1, to determine the to-be-performed task TL in the conversation record R1.

After determining the to-be-performed task TL, the task generation unit 166 calls and integrates different tasks through an application programming interface (API), and manages and schedules specific trigger timing of multiple tasks.

In an example, the to-be-performed task TL generated by the task generation unit 166 refers to performing a map application program and annotating a specific site (such as the site in the conversation record R1); refers to performing a calendar program and annotating a specific date (such as a date in the conversation record R1); or refers to performing an address-book program and obtaining communication data of a specific object (such as a contact in the conversation record R1).

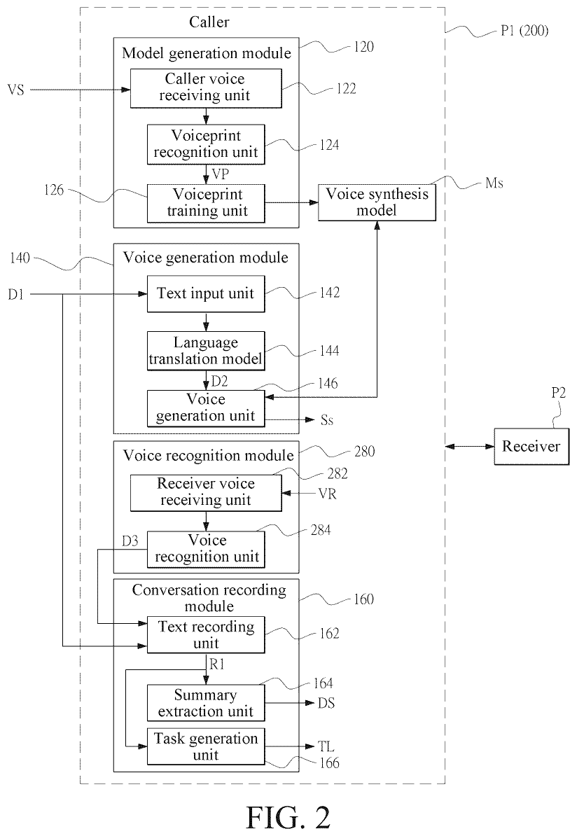

FIG. 2 is a schematic diagram of a voice communication system 200 according to another embodiment of the disclosure.

A main difference between the voice communication system 200 in this embodiment and that in the embodiment of FIG. 1 is that the voice communication system 200 in this embodiment further includes a voice recognition module 280. The voice recognition module 280 includes a receiver voice receiving unit 282 and a voice recognition unit 284.

The receiver voice receiving unit 282 is configured to obtain a reply voice VR of the receiver P2. The reply voice VR is a reply of the user of the receiver P2 according to the synthesized voice Ss. The voice recognition unit 284 is electrically connected to the receiver voice receiving unit 282, and is configured to convert the reply voice VR into reply text D3.

According to the voice recognition module 280 provided in this embodiment, the voice communication system 200 obtains the reply voice VR of the receiver P2 in real time, and converts the reply voice VR into the reply text D3, to help the user to completely record dialog content between two parties of a dialog.

In addition, compared with that the text recording unit 162 of the conversation recording module 160 in the embodiment of FIG. 1 records only the caller text D1 of the caller P1, the text recording unit 162 in this embodiment is electrically connected to the text input unit 142 and the voice recognition unit 284, and is configured to record the caller text D1 and the reply text D3 in chronological order to generate the conversation record R1.

In an embodiment, the conversation recording module 160 further includes a summary extraction unit 164. The summary extraction unit 164 is configured to convert the conversation record R1 into summary text DS, to help the user to review the record.

In an embodiment, the conversation recording module 160 further includes a task generation unit 166. The task generation unit 166 is configured to analyze the conversation record R1 to generate at least one to-be-performed task TL.

In an example, the to-be-performed task TL refers to performing a map application program and annotating a specific site (such as the site in the conversation record R1); refers to performing a calendar program and annotating a specific date (such as a date in the conversation record R1); or refers to performing an address-book program and obtaining communication data of a specific object (such as a contact in the conversation record R1).

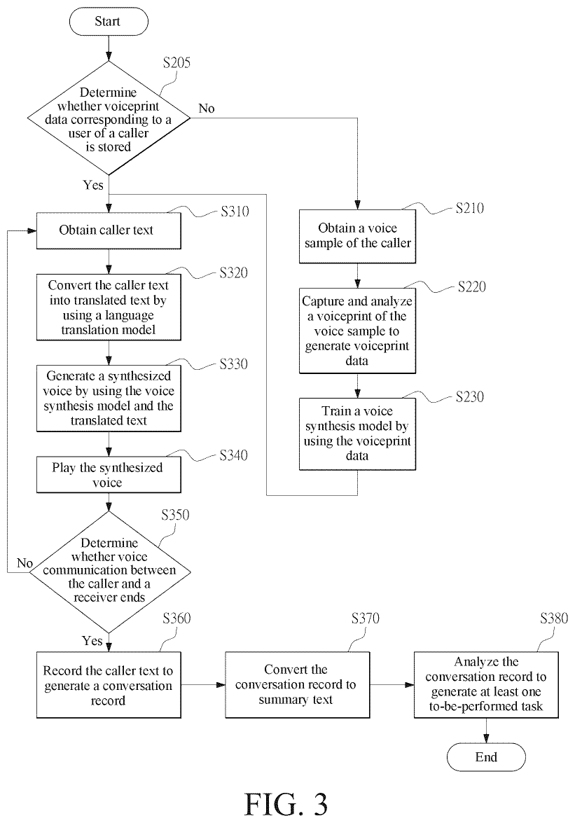

FIG. 3 is a flowchart of a voice communication method according to an embodiment of the disclosure.

The voice communication method is used in combination with the voice communication system 100 shown in FIG. 1, and is suitable for a caller P1. The caller P1 is used for voice communicating with a receiver P2.

As shown in the figure, the voice communication method is generally divided into a model generation stage, a communication stage, and a post-communication stage. The voice communication method includes the following steps.

Step S205: Determine whether a voiceprint data VP corresponding to a user of the caller P1 is stored. When it is determined that the voiceprint data VP corresponding to the user of the caller P1 is stored, in this procedure, the model generation stage is skipped to directly enter the communication stage. When it is determined that the voiceprint data VP corresponding to the user of the caller P1 is not stored, in this procedure, step S210 is performed, to enter the model generation stage.

In the foregoing steps, whether the model generation stage is skipped is determined according to whether a voiceprint data VP corresponding to a specific user is stored. However, the disclosure is not limited thereto. In other embodiments, whether the model generation stage is skipped is also determined according to whether a voice sample VS corresponding to the specific user is stored, or according to directly determining whether establishment of a voice synthesis model Ms corresponding to the specific user is completed.

Additionally, when a name of the user annotated by the stored voiceprint data VP and a name of a user in current communication are different, the voice communication system 100 still requires to perform steps of the model generation stage.

The model generation stage includes the following steps. Step S210: Obtain a voice sample VS of the caller P1. This step is performed by a caller voice receiving unit 122 in FIG. 1.

Step S220: Capture and analyze a voiceprint of the voice sample VS to generate voiceprint data VP. This step is performed by a voiceprint recognition unit 124 in FIG. 1. In an embodiment, the voiceprint recognition unit 124 supplements and analyzes voiceprint features of the voice sample VS, such as a sound frequency, sound intensity, and rhythm, to generate the voiceprint data VP.

Step S230: Train a voice synthesis model Ms by using the voiceprint data VP. This step is performed by a voiceprint training unit 126 in FIG. 1. The voice synthesis model Ms is a deep learning model.

In an embodiment, in the model generation stage, step S210 to step S230 are repeated a particular number of times, and the user of the caller P1 is asked to provide voice samples VS with different content, to improve output quality of the voice synthesis model Ms.

The communication stage includes the following steps. Step S310: Obtain caller text D1. This step is performed by a text input unit 142 in FIG. 1. Step S320: Convert the caller text D1 into translated text D2 by using a language translation model 144.

Step S330: Generate a synthesized voice Ss by using the voice synthesis model Ms trained in the model generation stage and the translated text D2 obtained through conversion in step S320; This step is performed by a voice generation unit 146 in FIG. 1.

Step S340: Play the synthesized voice Ss. Specifically, in this step, the synthesized voice Ss generated in step S330 is transmitted to the receiver P2.

Subsequently, in this procedure, step S350 is performed, to determine whether voice communication between the caller P1 and the receiver P2 ends. In an example, whether the voice communication ends is determined according to whether a voice conversation application program is closed, or whether the receiver P2 leaves the conversation.

When the voice communication between the caller P1 and the receiver P2 ends, in this procedure, the post-communication stage is performed. When the voice communication between the caller P1 and the receiver P2 does not end, in this procedure, step S310 is performed, and step S310 to step S340 are repeated.

The post-communication stage includes the following steps. Step S360: Record the caller text D1 to generate a conversation record R1. This step is performed by a text recording unit 162 in FIG. 1.

Step S370: Convert the conversation record R1 into summary text DS. This step is performed by a summary extraction unit 164 in FIG. 1.

Step S380: Analyze the conversation record R1 to generate at least one to-be-performed task TL. This step is performed by a task generation unit 166 in FIG. 1.

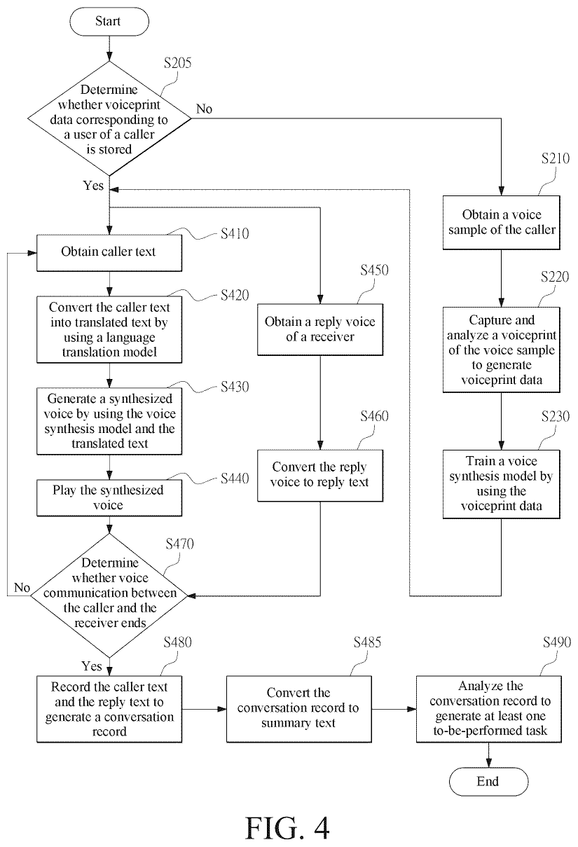

FIG. 4 is a flowchart of a voice communication method according to another embodiment of the disclosure.

The voice communication method is used in combination with the voice communication system 200 shown in FIG. 2, and is suitable for a caller P1. The caller P1 is used for voice communicating with a receiver P2.

Similar to the embodiment of FIG. 3, the voice communication method in this embodiment is also divided into a model generation stage, a communication stage, and a post-communication stage. Steps of the model generation stage involved in FIG. 4 are equivalent to those in FIG. 3 and expressed with the same symbols. Therefore, they are not illustrated herein.

However, compared with the embodiment of FIG. 3, in the communication stage in the voice communication method in this embodiment, in addition to that the synthesized voice Ss is generated by using caller text D1 obtained by the caller P1 (corresponding to step S410 to step S440 in the figure), a reply voice VR of the receiver P2 is also obtained. The step of generating the synthesized voice Ss by using the caller text D1 obtained by the caller P1 is similar to step S310 to step S340 in FIG. 3. Therefore, this is not illustrated herein.

Processing steps of obtaining the reply voice VR of the receiver P2 are described as follows. Step S450: Obtain the reply voice VR of the receiver P2 after entering the communication stage. This step is performed by a receiver voice receiving unit 282 in FIG. 2. Step S460: Convert the reply voice VR into reply text D3. This step is performed by a voice recognition unit 284 in FIG. 2.

Next, in this procedure, step S470 is performed, to determine whether voice communication between the caller P1 and the receiver P2 ends. The step is similar to step S350 in FIG. 3. In an example, whether the voice communication ends is determined according to whether a voice conversation application program is closed, or whether the receiver P2 leaves the conversation.

When the voice communication between the caller P1 and the receiver P2 does not end, in this procedure, step S410 and step S450 are performed, and step S410 to step S440 and step S450 to step S460 are repeated. When the voice communication between the caller P1 and the receiver P2 ends, in this procedure, the post-communication stage is performed.

The post-communication stage includes the following steps. Step S480: Record the caller text D1 and the reply text D3 to generate a conversation record R1. This step is performed by a text recording unit 162 in FIG. 2.

Step S485: Convert the conversation record R1 into summary text DS. This step is performed by a summary extraction unit 164 in FIG. 2.

Step S490: Analyze the conversation record R1 to generate at least one to-be-performed task TL. This step is performed by a task generation unit 166 in FIG. 2.

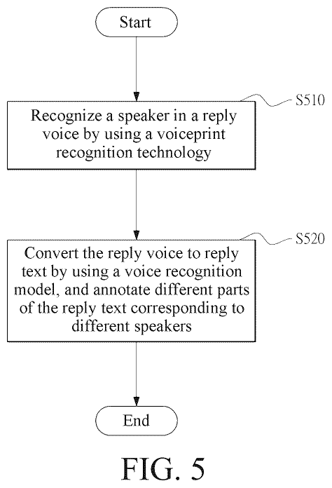

FIG. 5 shows an embodiment of step S460 in FIG. 4.

As shown in the figure, in an embodiment, in step S460, the converting the reply voice VR into reply text D3 includes the following substeps.

Substep S510: Recognize a speaker in the reply voice VR by using a voiceprint recognition technology. In an embodiment, the speaker in the reply voice VR is determined by comparing diversity of sound features (such as a pitch, a tonality, and timbre). When the diversity of the sound features is greater than a preset degree, the sound features are annotated to belong to different speakers.

Substep S520: Convert the reply voice VR into the reply text D3 by using a voice recognition model, and annotate different parts of the reply text D3 corresponding to different speakers.

The caller text D1 and the annotated reply text D3 are used for generating the conversation record R1. Different parts of different speakers in the conversation record R1 are annotated, to help the user to organize dialog content.

According to the voice communication systems 100 and 200 and the voice communication method provided in the disclosure, caller text D1 is converted into translated text D2 in real time by using a language translation model 144, and a synthesized voice Ss is also generated in real time based on the translated text D2 by using a language synthesis model and transmitted to a receiver P2. This helps to resolve the problem of difficult trans-language voice communication during conventional voice communication. In addition, according to the voice communication systems 100 and 200 and the voice communication method provided in the disclosure, during communication, the caller text D1 and reply text D3 of the receiver P2 are also recorded to generate a conversation record R1. This helps to resolve the problem of inconvenient recording during the conventional voice communication.

The above is only preferred embodiments of the disclosure, and there is no restriction on the disclosure. Any identical replacement and changes by the skilled person in the prior art, within the scope of the techniques of the disclosure, on the techniques and content which the disclosure provides are not out of the techniques of the disclosure and still within the scope of the disclosure.

What is claimed is:

1. A voice communication system, suitable for a caller, wherein the caller is used for voice communicating with a receiver, and the voice communication system comprises:
a caller voice receiving unit, configured to obtain a voice sample of the caller;
a voiceprint recognition unit, electrically connected to the caller voice receiving unit, and configured to capture and analyze a voiceprint of the voice sample to generate voiceprint data;
a voiceprint training unit, electrically connected to the voiceprint recognition unit, and configured to train a voice synthesis model by using the voiceprint data;
a text input unit, configured to obtain caller text;
a language translation model, electrically connected to the text input unit, and configured to convert the caller text into translated text;
a voice generation unit, electrically connected to the voiceprint training unit and the language translation model, and configured to generate a synthesized voice by using the voice synthesis model and the translated text;
a receiver voice receiving unit, configured to obtain a reply voice of the receiver;
a voice recognition unit, electrically connected to the receiver voice receiving unit, and configured to convert the reply voice into reply text; and
a text recording unit, electrically connected to the text input unit and the voice recognition unit, and configured to record the caller text and the reply text to generate a conversation record.

2. The voice communication system according to claim 1, further comprising a summary extraction unit, electrically connected to the text recording unit, and configured to convert the conversation record into summary text.

3. The voice communication system according to claim 1, further comprising a task generation unit, electrically connected to the text recording unit, and configured to analyze the conversation record to generate at least one to-be-performed task.

4. The voice communication system according to claim 3, wherein the to-be-performed task corresponds to at least one of a group formed by a map application program, a calendar program, and an address-book program.

5. The voice communication system according to claim 1, wherein a language of the caller text and a language of the translated text are different.

6. A voice communication method, suitable for a caller, wherein the caller is used for voice communicating with a receiver, and the voice communication method comprises:
a model generation stage, comprising:
obtaining a voice sample of the caller;
capturing and analyzing a voiceprint of the voice sample to generate voiceprint data; and
training a voice synthesis model by using the voiceprint data;
a communication stage, comprising:
obtaining caller text;
converting the caller text into translated text by using a language translation model; and
generating a synthesized voice by using the voice synthesis model and the translated text; and
a post-communication stage, comprising:
recording the caller text to generate a conversation record.

7. The voice communication method according to claim 6, wherein a language of the caller text and a language of the translated text are different.

8. The voice communication method according to claim 6, before entering the model generation stage, further comprising:
determining whether the voiceprint data corresponding to a user of the caller is stored, and directly entering the communication stage after it is determined that the voiceprint data corresponding to the user of the caller is stored.

9. The voice communication method according to claim 6, before entering the post-communication stage, further comprising:
determining whether the voice communication between the caller and the receiver ends, and directly entering the post-communication stage after it is determined that the voice communication between the caller and the receiver ends.

10. A voice communication method, suitable for a caller, wherein the caller is used for voice communicating with a receiver, and the voice communication method comprises:
a model generation stage, comprising:
obtaining a voice sample of the caller;
capturing and analyzing a voiceprint of the voice sample to generate voiceprint data; and
training a voice synthesis model by using the voiceprint data;
a communication stage, comprising:
obtaining caller text through the caller;
converting the caller text into translated text by using a language translation model;
generating a synthesized voice by using the voice synthesis model and the translated text;
obtaining a reply voice through the receiver; and
converting the reply voice into reply text; and
a post-communication stage, comprising:
recording the caller text and the reply text to generate a conversation record.

11. The voice communication method according to claim 10, wherein the step of converting the reply voice into the reply text comprises:
recognizing at least one speaker in the reply voice by using a voiceprint recognition technology; and
converting the reply voice into the reply text by using a voice recognition model, and annotating parts of the reply text corresponding to the speaker.
